(19) United States
(12) Patent Application Publication
(10) Pub. No.: US 2006/0136452 A1
(43) Pub. Date: Jun. 22, 2006

(54) Method of generating database schema to provide integrated view of dispersed data and data integrating system

(76) Inventors: Myung Eun Lim, Daejeon-city (KR); Myung Guen Chung, Incheon-city (KR); Myung Nam Bae, Daejeon-city (KR); Seon Hee Park, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/184,623

(22) Filed: Jul. 19, 2005

(30) Foreign Application Priority Data
Dec. 22, 2004 (KR) 10-2004-0110351

(51) Int. Cl. G06F 17/00

(52) U.S. Cl. 707/101

(57) ABSTRACT

A method for generating a database schema in order to generate an integrated view capable of obtaining desired data from data resources dispersed and stored in different formats in different locations, and an data integrating system are provided. The method includes rules for parsing the structure and contents of an database described in a specification language, generating a schema semantically corresponding to the database, and defining data items required for generating an integrated view. Also, in order to generate a global schema expressing an integrated view, part of XQuery grammar is introduced for local schemas expressing a single database, and a definition of standard expression for expressing a data view is included. Accordingly, an data integrating system can generate an integrated view for a variety of heterogeneous databases dispersed on a network by using a specification language, and post a query in real time.

### CROSS-REFERENCE TO RELATED PATENT APPLICATIONS

This application claims the benefit of Korean Patent Application No. 10-2004-0110351, filed on Dec. 22, 2004, in the Korean Intellectual Property Office, the disclosure of which is incorporated herein in its entirety by reference.

### BACKGROUND OF THE INVENTION

1. Field of the Invention

The present invention relates to a database integrating technology, and more particularly, to a method for generating a database schema in order to generate an integrated view capable of obtaining desired data from data resources dispersed and stored in different formats in different locations, and data integrating system.

2. Description of the Related Art

Due to the recent development of networking technologies and greater use of the internet, an environment is being established where various and large data items are dispersed in different forms in different locations. In particular, in the field of biological data, as the sequences of genes have been identified with the human genome project, a variety of biological data research has been conducted, and as a result, a variety of results have been stored in databases and provided on the internet. Accordingly, user can access databases dispersed in a variety of formats.

However, due to the variety and huge amount of data, it is difficult for users to find the desired data from a variety of data resources in different locations, and in addition, finding the desired data requires much time and effort. Also, expert knowledge is required for users to obtain the desired data in an integrated form by processing data from heterogeneous data resources into a desired format.

Meanwhile, in order to solve these problems, a variety of database integrating methods, such as data warehouse, data mart, and wrapper-mediator, which provide data integration of dispersed heterogeneous data resources, have been proposed. These methods are trials to provide an integrated view of data by providing legacy data with meanings. However, technology such as data warehouse and data mart lack adaptability to dynamic data changes, while the wrapper-mediator model cannot provide a general approaching method because each data resource requires the use of a unique language for data access. Furthermore, these methods cannot effectively express close relations between databases of biological data.

### SUMMARY OF THE INVENTION

The present invention provides a method and apparatus for generating a more general and efficient database schema in order to generate an integrated view capable of obtaining desired data from data resources dispersed and stored in different formats in different locations.

According to an aspect of the present invention, there is provided a schema generation method for a dispersed database, including: parsing a specification language document for the database and generating meta data; if the database is a local database, generating a local schema for each item of the parsed specification language document; and if the database is not a local database, parsing an input query and generating a global schema for each item of a return clause included in the parsed query.

The meta data may be data for managing the database and include uniform resource locator (URL) indicating the location of the database, the name of the database, and the type of the database, or a combination of these.

The generating of the local schema may include: in each item of the parsed specification language document, if a link containing a reference to another database is included in the item, examining the validity of the link; in each item of the parsed specification language document, converting a data item into a schema element; converting KEY and/or SEARCH operations included in the parsed specification language document into a search element; and converting CONSTRAINT indicating constraints included in the parsed specification language document into mapping data.

The generating of the global schema may include: for each item of a return clause included in the parsed query, examining the validity of a data item and converting the data item into a schema element; and for each item of the return clause included in the parsed query, extending CONSTRAINT indicating constraints and converting into a global schema and mapping data.

The schema element may be expressed as a complex type element capable of including another schema element below the schema element.

According to another aspect of the present invention, there is provided an data integrating system using a dispersed database, including: a query processing unit receiving a query on desired data from a user and dividing the query into local queries for each of the dispersed databases; a wrapper management unit managing at least one wrapper which performs the divided local query and transfers the result of the query to the query processing unit; and a schema management unit parsing a specification language document on the database and generating meta data, and if the database is a local database, generating a local schema for each item of the parsed specification language document, and if the database is not a local database, parsing the input query and generating a global schema for each item of a return clause included in the parsed query.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram of a biological data integrating system according to the present invention;

FIG. 2 is a flowchart of operations performed by a preprocessing unit of a method for generating a schema of a database described in a specification language according to the present invention;

FIG. 3 is a detailed flowchart of a method for generating a local schema (L) shown in FIG. 2;

FIG. 4 is a detailed flowchart of a method for generating a global schema (G) shown in FIG. 3;

FIG. 5 is a reference diagram explaining rules for converting a specification language document according to the present invention into a schema;

FIG. 6 illustrates an example of converting a specification language document into a schema; and

FIG. 7 illustrates an example of the extracting result of a wrapper.

### DETAILED DESCRIPTION OF THE INVENTION

The present invention will now be described more fully with reference to the accompanying drawings, in which exemplary embodiments of the invention are shown.

The present invention is an extended model of a wrapper-mediator based integration method with a specialized function, by reflecting the characteristics of a biological database in the conventional wrapper-mediator based data integration method. According to the present invention, by using an intuitive specification language, a local database is described, and in order to generate an integrated view, constraints restricting and merging the local database can be described.

Biological data sources on the internet are described as a semi-structured format having a regular pattern, and these patterns can be expressed by a regular expression.

The specification language used in the present invention supports a regular expression of a standard draft of the World Wide Web Consortium (W3C) in order to define an extraction rule for biological data resources. Accordingly, it can be flexibly used to describe biological data.

Since biological databases have closer relations between heterogeneous databases compared to ordinary databases, one local database frequently refers to two or more local databases.

A biological data integrating system according to the present invention introduces a link concept for reference to another database included in a local database, and can provide an integrated view for related databases with one request.

Also, in the biological data integrating system according the present invention, data stored in local databases does not physically move to an integrated location, but a view is provided which virtually integrates the contents of each local database.

A user posts a query for desired data through a provided integrated view. For this, a wrapper is needed, which is a data storage place that directly interfaces with each local database. That is, the wrapper is declared by using a specification language, and is obtained by compiling the declaration. This wrapper recognizes the structure of an object biological database and data on other biological data according to the specification, and identifies all the operations provided by the object biological data search system. Based on this, the wrapper extracts a variety of data items requested from the object biological database, and provides a variety of meta-data items on these. One wrapper corresponds to a local database, and provides data to form an integrated view by transferring the contents of the local database to a biological data integrating system. Also, the wrapper transfers a query received from a user to the local database, and transfers the result of the query to the biological data integrating system.

At this time, in order for the wrapper to transfer the contents of the local database to the biological data integrating system, different specifications of each local database should be converted into a schema indicating the structure of one neutral database. For this, the present invention uses an extensible markup language (XML) schema according to the recommendation of the W3C standard draft. Also, an XML view desired by a user is defined by an XQuery, which is a query language complying with the specification language and the recommendation of the W3C standard draft described above. If the definition of an integrated view using the specification language and the query language XQuery is made, a virtual XML schema is generated from this. Accordingly, in the present invention, a method and apparatus for converting a database or a view described in a specification language to an XML schema are provided.

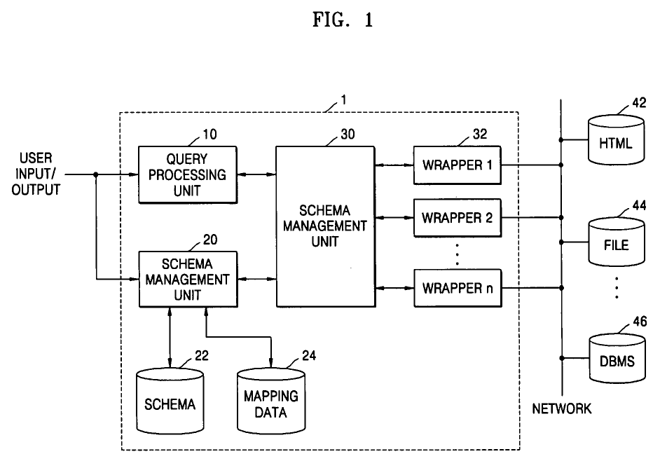

Referring to FIG. 1, a biological data integrating system includes a query processing unit 10, a schema management unit 20, and a wrapper management unit 30. Also, wrappers 32 for a plurality of heterogeneous databases are included. Each wrapper is connected to one of a variety of heterogeneous local databases 42 through 46 through a network. If a user query for an integrated model is input through a user interface (not shown), the query processing unit 10 parses the XQuery, divides it into local queries, and then transfers the queries to the wrappers 32 for extracting data from the local databases. The query processing unit 10 integrates generated from the respective wrappers and provides the query processing results to the user.

The user can define data items to be extracted from a specific database by using the specification language (which will be described later), and describe constraints for these items. If a specification language document is made, the schema management unit 20 generates a local schema or a global schema and maps data of the database. The local schema is a specification of data for a single database, and the global schema is a specification for an integrated view generated by restricting specific items of a plurality of local databases.

When constraints for the schema are described, the mapping data is generated and includes reference conditions on a local schema referred to by a global schema or constraints in a local schema itself.

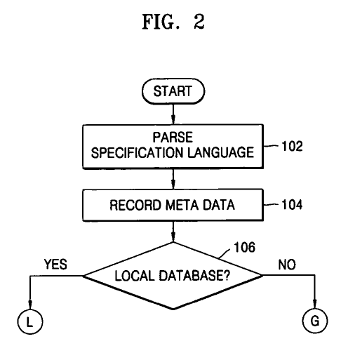

FIG. 2 is a flowchart of operations performed in a method for generating a schema of a database described in a specification language according to the present invention.

Referring to FIG. 2, a user can describe a local schema for a single database in a specification language, or describe a global schema by referring to two or more single databases according to a using purpose of data. The schema is broken down into a global schema and a local schema according to the type data indicating the type of database described in a specification language document. If a specification language document is input, a specification language parser included in the schema management unit 20 parses the specification language document in operation 102, interprets the parsed data and record meta data in operation 104. Then, according to the type data of the database described in the specification language, an operation for generating a local schema and an operation for generating a global schema are separately processed, in operation 106.

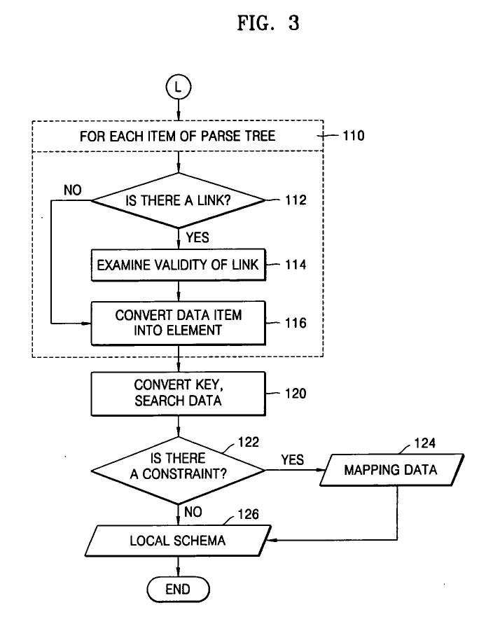

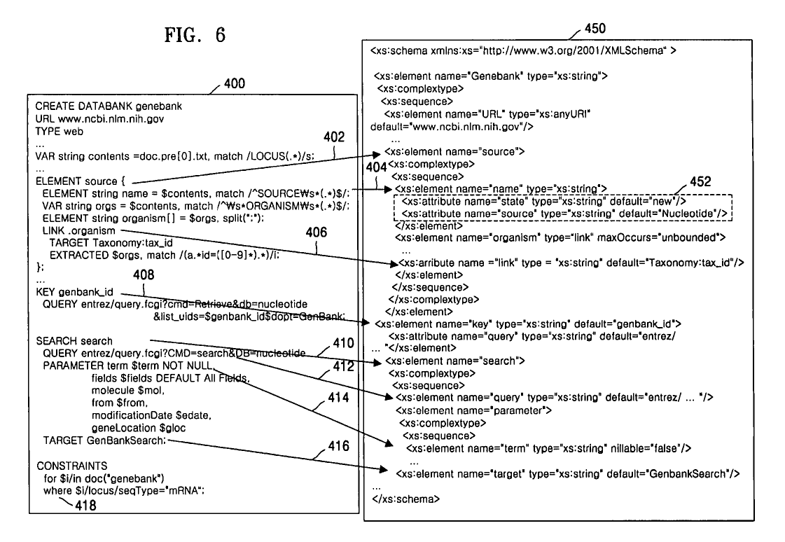

More specifically, FIG. 3 is a detailed flowchart of a method for generating a local schema (L) shown in FIG. 2. Also, FIG. 6 illustrates an example of converting a specification language document into a schema.

First, referring to FIG. 6, in the specification language document 400 for a local schema, data items 402 through 406 to be converted into elements of an XML schema 450 are described together with extraction rules. Each item of the specification language document is converted into an element of the XML schema according to the conversion rules to be described later. In particular, for the element 406 including a reference to another database, a link attribute of the XML schema is additionally generated. In addition, as described above, after each data item is converted into an element of the XML schema, conversion of an operation description part described later is performed. At this time, if there are CONSTRAINTS describing constraints on data, only those items described below Return clause of CONSTRAINT are reflected in the local schema. The reflected constraints are stored in the mapping data 24 in the form of an XML document. CONSTRAINTS are described in the form of an XQuery.

Referring to FIG. 3, the local schema conversion method described above will now be explained briefly. It is confirmed whether or not there is a LINK item including a reference to another database, in each item of the parse tree generated through the operations 102 through 104 described above in operation 112. If there is a LINK item, the validity of LINK is examined in operation 114, and the LINK item is converted into an element of the XML schema in operation 116. Then, a KEY or SEARCH item corresponding to the description of an operation is converted into a corresponding element of the XML schema in operation 120. Also, if there is a CONSTRAINTS item describing constraints in operation 122, in the data satisfying the conditions described below Where clause, only those data items described below Return clause of CONSTRAINTS are reflected in the local schema in operation 126. The reflected constraints are stored in the mapping data 124 in the form of an XML document. Specific rules for converting each item included in a specification document into an XML schema will be explained later.

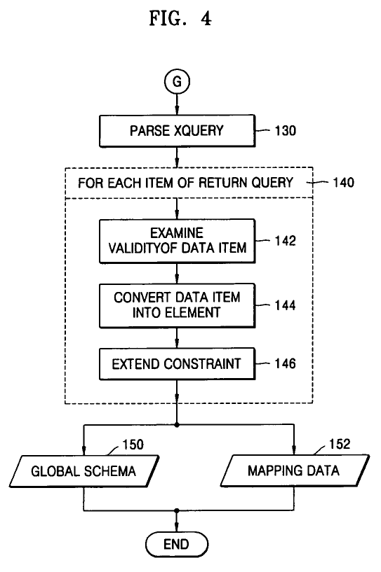

Meanwhile, FIG. 4 is a detailed flowchart of a method for generating a global schema (G) shown in FIG. 3.

Referring to FIG. 4, a specification language document of a global schema is described centered around CONSTRAINTS. The XQuery of CONSTRAINTS is parsed in operation 130, and in the database referred to in a For clause, data satisfying constraints described in a Where clause are formed as data items defined in a Return clause. At this time, the database referred to by the For clause should be registered in advance as a local schema or a global schema. If the validity examination of the database referred to is thus finished in operation 142, each data item of the specification language document is converted into an element of the XML schema in operation 144. At this time, as shown in operation 452 of FIG. 6, in order to maintain local schema data referred to when conversion is performed, separate attribute fields are additionally maintained. Meanwhile, when constraints for the database referred to are stored in the mapping data 152, the constraints are merged with conditions below Where clause of current constraints and stored in the mapping data 152. In the mapping data 152 integration of constraints and reference conditions for the reference database are described, and the mapping data 152 is referred to when the user query is divided into local queries for respective wrappers.

More specific rules for converting each item included in a specification language document into an XML schema based on the schema generation apparatus and method described above will now be explained in more detail.

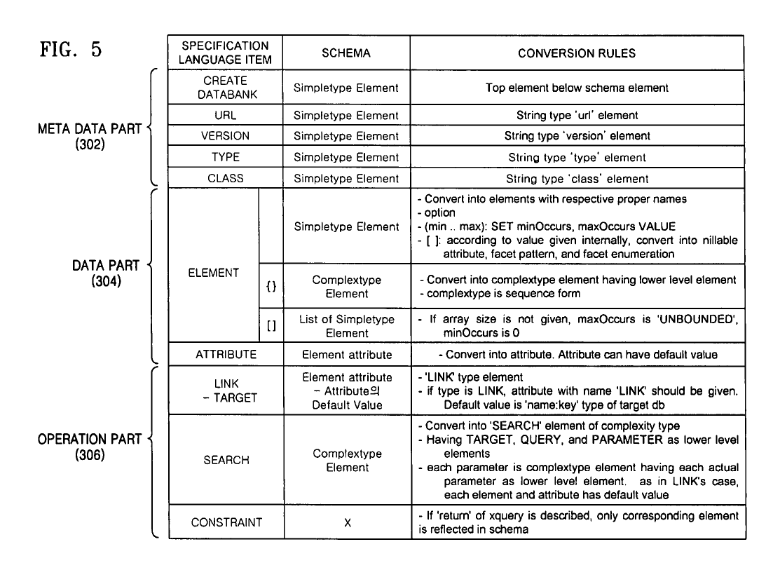

FIG. 5 is a reference diagram explaining rules for converting a specification language document according to the present invention into a schema.

Referring to FIGS. 5 and 6, the specification language document is divided into a meta data part 302, a data part 304, and an operation part 306. The meta data part 302 includes data required for maintaining a database, such as a URL indicating the location of a database, the name of a database, and the type of a database. The data part 304 defines data items included in the XML schema and rules for extracting the data items. In the operation part 306 are defined KEY, that is a search criterion in order to guarantee the uniqueness of data in an actual source database, SEARCH, that defines parameters required for search not using KEY, CONSTRAINTS describing constraints, and LINK specifying a reference to a database.

In the present invention, in addition to a Simpletype element support by an XML schema, a description method of a Complextype element is also provided. The Complextype element defines the structure of data having another elements below the element itself recursively. For example, the element indicated by 404 of FIG. 6 is a complex element. In addition, an expression supporting nillable, min, maxOccurs, and facet attributes of an element supported in the XML schema grammar is provided. Also, a link has the name of a database which is to be an object of reference and a key value of the object database as default values.

FIG. 6 illustrates an example of converting a specification language document into a schema.

Referring to FIG. 6, the specification language document 400 is converted into an XML schema 450 according to the conversion rule described above.

VAR defines a variable to be used in a specification language document. In the specification language document of a source database, content to be processed is stored in a temporary variable, and the variable is appropriately processed and used to generate data items.

Also, all elements and attributes excluding Complextype elements have respective data types. A data type is used to restrict the expression scope of data, and integer, double, string, date, and Boolean types that can be used in an XML schema are provided.

As described above in the global schema generation method of FIG. 3, each element has attributes of source and state 452 in order to express the source of the element. The source attribute has data on the database on which the element is based on when generated, and the state attribute has data on the newness of the element and whether or not an existing element is reused. This data is used to find a local schema to be referred to when data for a global schema is collected.

Meanwhile, KEY 408 describes basic search conditions for a source database. An item defined as KEY is a basic item guaranteeing the uniqueness of data in the source database, and for one KEY value, a single data item is retrieved. QUERY 412 of KEY means a retrieval method using KEY, that is, the retrieval address. When data is retrieved using a corresponding KEY in an actual wrapper 32, the retrieval result is obtained by referring to the address of QUERY.

Also, SEARCH 410 describes the retrieval conditions except for KEY. An ordinary biological database is formed such that retrieval without KEY is enabled. Other retrieval references than KEY can be defined as PARAMETER and then used. Each PARAMETER can define a DEFAULT value and NOT NULL 414 as options. NOT NULL indicates a value that should be input, and DEFAULT indicates a value to be used when the user does not input a value. TARGET item 416 of SEARCH indicates a specification for another wrapper to process data to be extracted after SEARCH retrieval. In the case of retrieval which does not use a basic key, one or more data items are arranged in the form of a list, and a rule for extracting the list in a data format described in the schema is performed in the wrapper defined in TARGET.

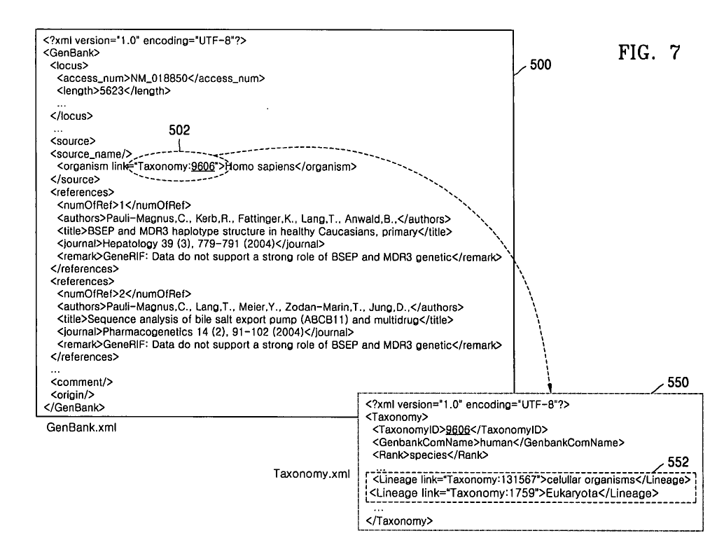

FIG. 7 illustrates an example of the extracting result of a wrapper.

Referring to FIG. 7, the actual data extraction result of a wrapper for a local schema is shown. Reference number 500 indicates an extraction example for GenBank local schema, and reference number 550 indicates an extraction example for Taxonomy local schema. The result of defining LINK in the organism element 406 of FIG. 6 is indicated by reference number 502 of FIG. 7. Homo Sapiens data is defined in Taxonomy database with KEY being 9606, and the result of searching the actual Taxonomy database with KEY is shown as the example 550. As an example indicated by reference number 552, LINK can also indicate its own database in addition to other databases.

Meanwhile, the schema generation method according to the present invention can be implemented as a computer program. Code and code segments forming the program can be easily inferred by programmers in the technology field of the present invention. Also, the program is stored in computer readable media, and read and executed by a computer to implement the schema generation method. The computer readable media includes magnetic recording media, optical recording media and carrier wave media.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in a descriptive sense only and not for purposes of limitation. Therefore, the scope of the invention is defined not by the detailed description of the invention but by the appended claims, and all differences within the scope will be construed as being included in the present invention.

According to the present invention as described above, in order to generate an integrated view obtaining desired biological data from biological data resources dispersed over networks, a schema generation method and apparatus for generating a more efficient and general database schema are provided.

Accordingly, a biological data integrating system capable of generating an integrated view using a specification language and posting a query in real time to a variety of heterogeneous databases dispersed on a network can be provided. Users can actively integrate and manipulate data by the using biological data integrating system.

In addition, since regular expressions familiar to biologists are introduced into a specification language, and the standardized query language XQuery is used, One who is not an expert, can easily use the integrating system.

Furthermore, by introducing a link concept, reference data between databases can be viewed organically, and a variety of search paths for a source are provided and a processing method for a result is provided such that a biological data integrating database can be flexibly established.

What is claimed is:

1. A schema generation method for a dispersed database, comprising:
parsing a specification language document for the database and generating meta-data;
if the database is a local database, generating a local schema for each item of the parsed specification language document; and
if the database is not a local database, parsing an input query and generating a global schema for each item of a return clause included in the parsed query.

2. The method of claim 1, wherein the meta data is data for managing the database and includes a uniform resource locator (URL) indicating the location of the database, the name of the database, and the type of the database, or a combination of these.

3. The method of claim 1, wherein generating the local schema comprises:
in each item of the parsed specification language document, if a link containing a reference to another database is included in the item, examining the validity of the link;
in each item of the parsed specification language document, converting a data item into a schema element;
converting KEY and/or SEARCH operations included in the parsed specification language document into a search element; and
converting CONSTRAINT indicating constraints included in the parsed specification language document into mapping data.

4. The method of claim 1, wherein generating the global schema comprises:
for each item of a return clause included in the parsed query, examining the validity of a data item and converting the data item into a schema element; and
for each item of the return clause included in the parsed query, extending CONSTRAINT indicating constraints and converting into a global schema and mapping data.

5. The method of any one of claims 3 and 4, wherein the schema element is expressed as a complex type element capable of including another schema element below the schema element.

6. An data integrating system using dispersed databases, comprising:
a query processing unit which receives a query on desired data from a user and divides the query into local queries for each of the dispersed databases;
a wrapper management unit which manages at least one wrapper which performs the divided local query and transfers the result of the query to the query processing unit; and
a schema management unit which parses a specification language document on the database and generates meta data, and if the database is a local database, generates a local schema for each item of the parsed specification language document, and if the database is not a local database, parses the input query and generates a global schema for each item of a return clause included in the parsed query.

7. The apparatus of claim 6, wherein the meta data is data for managing the database, and includes a uniform resource locator (URL) indicating the location of the database, the name of the database, and the type of the database, or a combination of these.

8. The apparatus of claim 6, wherein if the database is a local database, and if each item of the parsed specification language document includes a link containing a reference to another database, then the schema management unit examines the validity of the link, in each item of the parsed specification language document, converts a data item into a schema element, converts KEY and/or SEARCH operations included in the parsed specification language document into a search element, and converts CONSTRAINT indicating constraints included in the parsed specification language document into mapping data.

9. The apparatus of claim 6, wherein if the database is a global database, then for each item of a return clause included in the parsed query, the schema management unit examines the validity of a data item and converts the data item into a schema element, and for each item of the return clause included in the parsed query, extends CONSTRAINT indicating constraints and converts into a global schema and mapping data.

10. The apparatus of any one of claims 8 and 9, wherein the schema element is expressed as a complex type element capable of including another schema element below the schema element.
